(19) United States
(12) Patent Application Publication
(10) Pub. No.: US 2014/0036222 A1
(43) Pub. Date: Feb. 6, 2014

(54) Spectacle Lens including a Base Lens and a Thin Structure

(71) Applicants: Christian Bovet, Charenton Le Pont (FR); Jean-Paul Cano, CHarenton Le Pont (FR); Romain Fayolle, Charenton Le Pont (FR); Antony Saugey, Charenton Le Pont (FR)

(72) Inventors: Christian Bovet, Charenton Le Pont (FR); Jean-Paul Cano, CHarenton Le Pont (FR); Romain Fayolle, Charenton Le Pont (FR); Antony Saugey, Charenton Le Pont (FR)

(21) Appl. No.: 13/995,077

(22) PCT Filed: Nov. 29, 2011
(86) PCT No.: PCT/FR11/52817

§ 371 Date: Oct. 17, 2013

(30) Foreign Application Priority Data
Dec. 15, 2010 (FR) 1060573

(51) Int. Cl. G02C 5/00; G02C 13/00

(52) U.S. Cl. CPC G02C 5/00; G02C 13/001
USPC 351/154; 351/178

(57) ABSTRACT

A spectacle lens comprising a base lens (1) and a thin structure (2) that are assembled with each other with an intermediate spacer (30). The spacer is situated along a peripheral edge (12) of the base lens, and a separation space that is determined by said spacer between said base lens and said thin structure contains a gaseous medium during use of the spectacle lens by a wearer. Assembly of the spectacle base lens with the thin structure may be permanent or removable.

The present invention concerns a spectacle lens comprising a base lens and a thin structure.

Combining a film with a spectacle base lens in order to provide additional properties and functions to the resulting spectacle lens is known. These properties and functions are produced by the film independently of the spectacle base lens. For example, the film may have an optical function, such as an anti-reflecting function; a mechanical function, such as an anti-impact or anti-scratch function; an anti-dirt function; an antistatic function; etc. Optionally, the film may have a complex thin structure that is able to produce a particular function. In particular, such a thin structure may comprise a layer of cells that each contain an optically active substance, such as a photochromic substance, a photo-transformable substance or liquid crystals. In the context of the present patent application, the more general terminology of thin structure is adopted, to designate both a film optionally carrying layers and a more complex structure, the external surfaces of which are parallel.

Such a combination of a thin structure with a spectacle base lens is different from producing a spectacle lens of variable power in the form of a reservoir with flexible faces that is filled with refracting liquid. Such a variable-power spectacle lens is in particular described in the document WO 2004/023167. The refractive liquid is then essential for the dioptric function of the lens to be achieved. However, the optical power of such a spectacle lens is not defined precisely, and the use of liquid for the ophthalmic application may reduce the safety of the spectacle wearer. Such a spectacle lens structure with variable optical power is outside the subject matter of the present patent application.

In a known manner, a thin structure may be assembled with a spectacle base lens by bonding on one of the faces of the latter, anterior or posterior. For this purpose, an intermediate layer of adhesive material is disposed between the thin structure and the spectacle base lens.

However, such an assembly method has the following drawbacks:
usually the thin structure is assembled definitively with the spectacle base lens without the possibility of separating them again subsequently, for example in order to change the thin structure;
when the face of the spectacle base lens is curved, the thin structure must be brought to an identical curvature. Stresses result from this in the thin structure, which may degrade it or cause delaminations of the thin structure with respect to the spectacle base lens;
a specific complex application tool is necessary for uniformly applying the thin structure to the spectacle base lens. This tool is expensive in itself and requires a skilled operator to use it; and
the application of the thin structure against the spectacle base lens may also cause scratches or crushing of the thin structure, which are liable to result in rejection of the product.

One object of the invention is then to propose another method of assembling a thin structure with a spectacle lens that does not have the above drawbacks.

To achieve this object and others, the present invention proposes a spectacle lens that comprises:
a spectacle base lens, rigid and delimited by a peripheral edge that laterally connects first and second opposite optical surfaces of this spectacle base lens;
a thin structure that is included between the first and second parallel surfaces thereof, and which extends in front of the first surface of the spectacle base lens; and
a spacer.

The spectacle lens is characterised in that the spacer comprises:
a central part that extends along at least part of the peripheral edge of the spectacle base lens, with a first support surface that is applied against the first surface of the spectacle base lens inside the peripheral edge, and a second support surface that is applied against the first surface of the thin structure, the first and second support surfaces of the spacer being opposite; and
a peripheral part continuously surrounding, by the periphery, the spectacle base lens and the thin structure, ensuring holding of these.

The central part of the spacer and the peripheral part of the spacer may form a single piece of complex shape or be two different elements assembled together, it being understood that a spacer comprising only a central part is not the subject matter of this invention.

The spacer also has a constant thickness between its first and second support surfaces. In addition, a separation volume that is determined by the spacer between the spectacle base lens and the thin structure contains a gaseous medium during a use of the spectacle lens by a wearer.

Thus a spectacle lens according to the invention has all the advantages that result from its formation in two components: the spectacle base lens on the one hand and the thin structure on the other hand. In particular, these two components can be obtained using manufacture and supply channels that are independent. An overall efficiency in production of the complete spectacle lens is thus improved.

According to the invention, the thin structure is not in contact with the spectacle base lens in an optically useful part thereof, outside the support surfaces of the spacer. The optical characteristics of the resulting spectacle lens are therefore not impaired by variations in the separation distance between the thin structure and the base lens. Thus such variations do not cause a reduction in the efficiency of manufacture of the final spectacle lens.

In addition, for the same reason, the assembly of the thin structure with the spectacle base lens does not require applying a compression force in parts of the thin structure and base lens that are optically useful. The risk of creating visible defects in these useful parts is thus eliminated, even if the thin structure is fragile and liable to be degraded by crushing.

The spacer may furthermore have one or other of the following features, or several of these combined with each other:
a cross-section of the spacer may be constant along the relevant part of the peripheral edge of the spectacle base lens;
the thickness of the spacer between the first and second support surfaces may be between 0.05 mm (millimetres) and 1.1 mm; and
the spacer may be in the form of a closed loop, with its first and second support surface which are continuous along the peripheral edge, and the thickness of the spacer constant along the closed loop.

In a first embodiment of the invention, the thin structure and the spectacle base lens are assembled permanently by assembly means. These assembly means comprise first assembly means and second assembly means. The first assembly means hold the first support surface of the spacer against the first surface of the spectacle base lens and form a first fixed material connection. The second assembly means hold the second support surface of the spacer against the first surface of the thin structure and form a second fixed material connection. For example, the first and second assembly means may consist of respective portions of adhesive material that are disposed on the support surfaces of the spacer.

In second embodiments of the invention, the thin structure and the base spectacles are assembled removably by assembly means. These assembly means comprise first assembly means and second assembly means. The first assembly means hold the first support surface of the spacer against the first surface of the spectacle base lens and may comprise a first rim of the spacer that enters a recess in the spectacle base lens, situated on the peripheral edge thereof. The spacer is then assembled with the base lens by inserting its first rim in the recess in the base lens. Such an assembly is simple and inexpensive and can be removed quickly. The second assembly means hold the second support surface of the spacer against the first surface of the thin structure and can themselves be permanent or removable. When they are permanent, the second assembly means may form once again a fixed material connection between the second support surface of the spacer and the first surface of the thin structure. When they are removable, the second assembly means comprise a second rim of the spacer that projects onto the second surface of the thin structure so that the latter is gripped between the second support surface and the second rim of the spacer.

The invention also proposes a method of producing a spectacle lens as described previously, which comprises the following steps:

/1/ obtaining a characterisation of a lens housing form in a frame that is intended to receive the spectacle lens;

/2/ trimming the spectacle base lens and producing the spacer in accordance with the housing in the frame;

/3/ cutting the thin structure in accordance with the first surface of the base lens;

/4/ assembling the spacer with the thin structure using the second assembly means; and then

/5/ after step /4/, assembling the whole comprising the thin structure and the spacer with the spectacle base lens using the first assembly means.

It is then possible to manufacture separately the whole that comprises the thin structure and the spacer assembled together, and to obtain moreover the spectacle base lens. For example, the thin structure can be assembled with the spacer in a dedicated workshop, for example in a centralised laboratory. Then the whole of the thin structure with the spacer can be sent between steps /4/ and /5/ to an optician, who in turn assembles it with the spectacle base lens. Such an embodiment of the final spectacle lens is both economical and compatible with the existing method of distributing ophthalmic equipment.

Other particularities and advantages of the present invention will appear in the following description of non-limitative example embodiments, with reference to the accompanying drawings, in which:

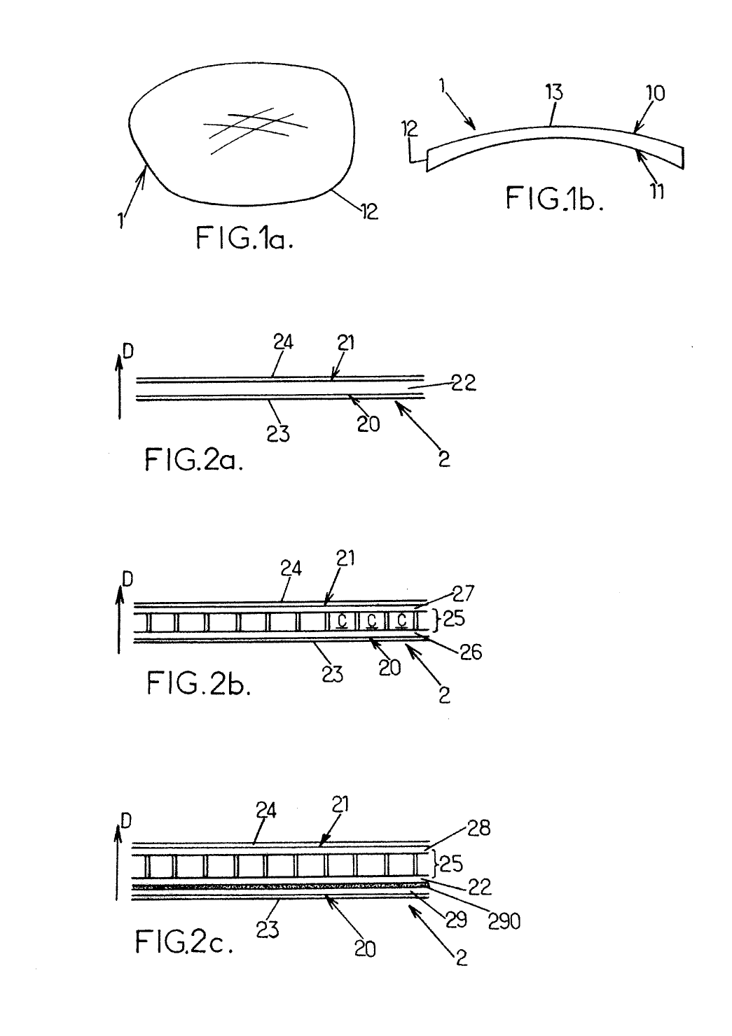

FIGS. 1a and 1b are in-plan view and side-view, respectively, of a spectacle base lens that can be used for implementing the invention;

FIGS. 2a to 2c are respective cross-sectional views of three thin structures that can be used for implementing the invention;

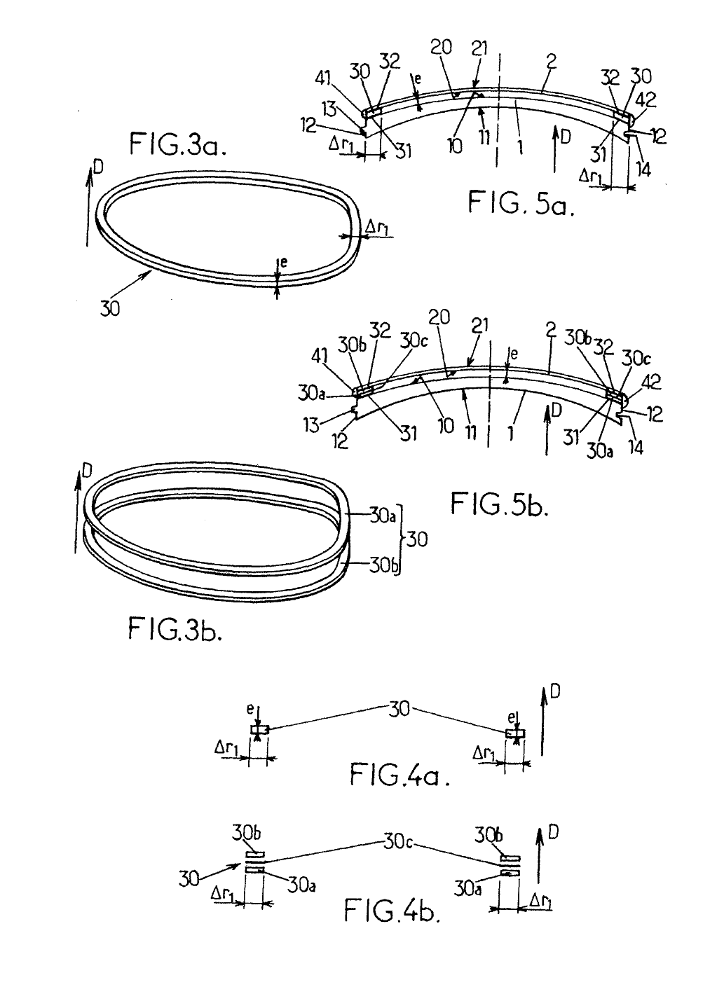

FIGS. 3a and 3b are perspective views of spacers that can be used for implementing the invention, according to two variants of a first embodiment of the invention;

FIGS. 4a and 4b are respective cross-sectional views of the spacers of FIGS. 3a and 3b;

FIGS. 5a and 5b are cross-sectional views of spectacle lenses produced according to the invention, respectively for the two variants of the first embodiment of the invention in FIGS. 3a and 3b;

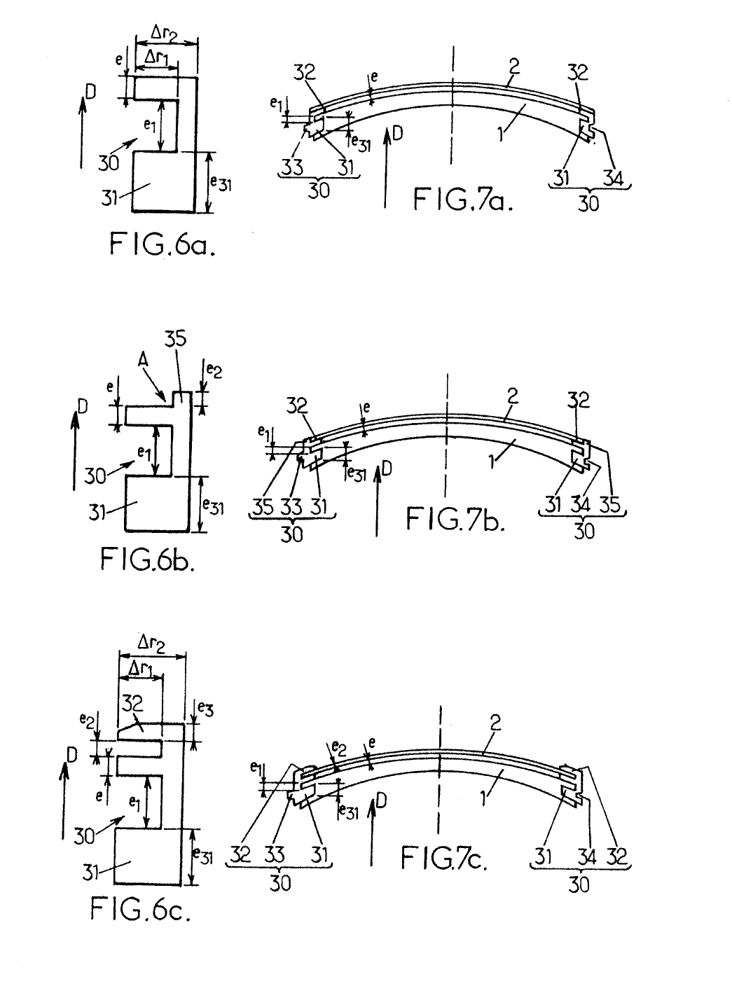

FIGS. 6a to 6c are respective cross-sectional views of spacers that can be used for implementing the invention, according to three variants of a second embodiment of the invention; and

FIGS. 7a to 7c are cross-sectional views of spectacle lenses produced according to the invention, respectively for the three variants of the second embodiment of the invention in FIGS. 6a to 6c.

For sake of clarity, the dimensions of the elements that are shown in these figures correspond neither to actual dimensions nor to actual ratios of dimensions. Furthermore, identical references that are indicated in different figures designate identical elements or ones that have identical functions.

In accordance with FIGS. 1a and 1b, a spectacle base lens 1 is trimmed in accordance with a lens housing in an ophthalmic spectacle frame. The base lens 1 may be of any type known before the present invention, for producing ophthalmic correction, for affording solar protection, or for fulfilling another function vis-à-vis the wearer. The base lens 1 could be used as it is by the wearer, when it is simply assembled in the spectacle frame. It has an anterior surface 10, a posterior surface 11 and a peripheral edge 12 that laterally connects the surfaces 10 and 11. The base lens 1 is rigid, with surfaces 10 and 11 that may be convex and concave respectively. Optionally, the surface 10 and/or the surface 11 may be complex, that is to say be continuous without step or break in slope, but with a variable curvature. Alternatively, the surface 10 and/or the surface 11 may be composed each of a juxtaposition of portions of individually continuous surfaces, and forming together the whole of the surface or surfaces 10 and/or 11. In elevation, the edge 12 is in the form of the housing of the ophthalmic frame. In a known manner, the edge 12 may have a conformation adapted for the relevant method for mounting the lens in the frame. For example, when the frame housing has a grooved hoop, the edge 12 may be provided with a projecting relief (not shown) that is adapted to enter the groove in the hoop. Alternatively, when the housing of the lens in the ophthalmic frame is open, the edge 12 may be provided with a groove adapted to receive a wire for holding the lens in the open housing of the frame.

In accordance with FIGS. 2a to 2c, a thin structure 2 has two parallel surfaces 20 and 21. The thin structure 2 may be flat, curved, flexible or rigid. Optionally, the thin structure 2 may have been preformed in order to have a curvature close to that of the surface 10 or 11 of the base lens 1 on top of which it is intended to be assembled. In accordance with FIG. 2a, the thin structure 2 may comprise at least one base film 22, this being able to be polarising, photochromic, absorbent, etc. Optionally, the thin structure 2 may also comprise a functional coating 23 or 24 on at least one of these two surfaces 20 and 21, for example a non-reflecting coating, an anti-scratch coating, an anti-dirt coating, etc., or a combination of such coatings.

The thin structure 2 may also have a cellular configuration, for example of the type in FIG. 2b or FIG. 2c.

In accordance with FIG. 2b, the thin structure 2 may have a multilayer constitution according to a direction D that is perpendicular to the surfaces 20 and 21.

According to a first possible configuration, the thin structure 2 may comprise at least:
a layer 25 of cells C that are juxtaposed parallel to the surfaces 20 and 21;
two films 26 and 27, which are situated on either side of the layer 25 of cells C, in the direction D; and
optionally, the functional coating 23 on the surface 20 and/or the functional coating 24 on the surface 21.

FIG. 2c shows a second possible cell-configuration for the thin structure 2. According to this second configuration, the thin structure 2 may comprise at least:
a base film 22;
a layer 25 of cells C that are juxtaposed parallel to the surfaces 20 and 21, the layer 25 being carried by the base film;
a film 28 for closing the cells C, which is situated on one side of the layer 25 opposite to the base film 22;
a first non-reflecting coating 24, which is carried by the cell-closing film 28 on a side opposite to the layer 25 of cells C;
an additional film 29 that is situated on one side of the base film 22 opposite to the layer 25 of cells C;
a second non-reflecting coating 23 that is carried by the additional film 29 on a side opposite to the base film 22; and
connection means 290 that connect the additional film 29 to the base film 22 on a side of the additional film 29 opposite to the second non-reflecting coating 23.

The connection means 290 may be an intermediate layer of adhesive material, according to one of the embodiments of such a layer that is known to persons skilled in the art.

Compositions of the functional coatings 23 and 24, possible materials for the films listed above, dimensions and embodiments of all these components, are also assumed to be known, so that it is not necessary to repeat them here. Likewise, it is known that the cells C may contain one or more active substances that confer on the thin structure 2 one or more additional optical functions.

Hereinafter, and by way of non-limitative illustration, it will be assumed that the spectacle base lens 1 and the thin structure 2 are assembled according to the invention with the surface 10 of the base lens 1 and the surface 20 of the thin structure 2 facing each other. In this assembly configuration, the surfaces 10 and 11 of the base lens 1 are respectively its first and second surface in the designation method that was used for the general part of the description of the invention. Thus the first optical surface of the spectacle base lens 1 may be convex. Likewise, the surfaces 20 and 21 of the thin structure 2 correspond respectively to its first and second surfaces, thus designated in the general part of the description.

The assembly then results in arranging the base lens 1 and the thin structure 2 with their respective faces 10 and 20 facing each other. In other words, the first respective surfaces of the base lens and of the thin structure are facing each other in the resulting spectacle lens. A separation space that is then present between the base lens and the thin structure is filled with a gaseous medium, for example air. Advantageously, the thin structure may have a curved shape, with a direction of curvature of the first surface of the thin structure opposite to that of the first optical surface of the spectacle base lens. This is because the separation space between the spectacle base lens and the thin structure may thus have a thickness that is substantially constant. The total thickness of the resulting spectacle lens is thus limited, so that this lens is more aesthetic.

In the spectacle lens that results from the assembly, the first optical surface of the spectacle base lens is protected by the thin structure. Such a configuration is particularly suitable when the first optical surface of the spectacle base lens has a discontinuity with a jump in sagittal height at at least one point on the surface. This is because the thin structure prevents dirt from being deposited in the surface discontinuity, and may impair the contribution of this discontinuous surface to the optical power of the base lens. In particular, the first optical surface of the spectacle base lens may thus be provided with a Fresnel structure, without problems of dirt and cleaning resulting therefrom.

Moreover, in order to reduce an increase in the total light reflection of the spectacle lens that might result from the presence of the separation space between the base lens and the thin structure, this separation space being filled with a gaseous medium, the respective first surfaces of the spectacle base lens and thin structure may advantageously be provided with respective non-reflecting coatings. Reference 13 in FIG. 1b designates such a non-reflecting coating that is carried by the surface 10 of the base lens 1. Likewise, the reference 23 in FIGS. 2a to 2c designates another non-reflecting coating that is carried by the first surface 20 of the thin structure 2. Optionally, the second surface 21 of the thin structure 2 may also be provided with a non-reflecting coating 24.

FIGS. 3 to 5 illustrate a first embodiment of the invention in which the base lens 1 and thin structure 2 are assembled permanently in order to form the final spectacle lens. FIGS. 3a, 4a and 5a correspond to a first variant of such a permanent assembly, and FIGS. 3b, 4b and 5b correspond to a second variant of a permanent assembly.

In the first variant permanent assembly, the spacer is comprised of two different pieces, a central part: the bead, and a peripheral part: the peripheral bead.

The central part of the spacer 30 consists of a bead of constant thickness e (FIG. 3a). Such a bead is preferably flexible in order to be caused to follow the form of the peripheral edge 12 of the base lens 1. In addition, its flexibility makes it possible to apply it in its entirety on the surface 10, which is curved. For example, the spacer 30 may be made from polyurethane (PU), preferably transparent for aesthetic reasons. It may have a rectangular cross-section (FIG. 4a), with the thickness E in the direction D that may be approximately 250 μm (micrometres) for example, and a width Δr₁ perpendicular to the direction D that may be approximately 600 μm for example. With respect to the direction D, the bottom and top surfaces of the spacer 30 constitute respectively a first and second support surface. First assembly means may then form a first material connection between the first support surface of the spacer 30 and the surface 10 of the spectacle base lens 1. Likewise, second assembly means may form a second material connection between the second support surface of the spacer 30 and the first surface 20 of the thin structure 2. These material connections may be lines of glue or adhesive material and, in a preferred assembly method, portions of a layer of a pressure-sensitive adhesive (PSA). Each of these portions of layers of adhesive material may be in the form of a band in a loop that covers the corresponding support surface of the spacer 30. In FIG. 5a, the reference 31 designates a first adhesive layer portion that is situated between the spacer 30 and the base lens 1, and the reference 32 designates a second portion of adhesive layer that is situated between the spacer 30 and the thin structure 2. The material connections that are thus formed are fixed.

According to an improvement to this first assembly method, a peripheral bead may be added straddling over a peripheral limit of the thin structure 2 that connects the first and second surfaces thereof, and over at least part of an external edge of the spacer 30 that connects its two support surfaces. Such a bead may have at least two functions. A first of these functions may consist of forming an edge sealing of the thin structure 2, in particular when the latter has a cellular structure as shown in FIGS. 2b and 2c. A second function of such a bead may be to increase the cohesion between the thin structure 2 and the spacer 30, in particular to reduce risks of delamination by rupture of the second assembly means. Preferably, such a bead, which may be made from polyethylene (PE) or polyurethane (PU), extends continuously and uniformly all around the thin structure 2 and the spacer 30. The left and right parts of FIG. 5a illustrate two possibilities for the arrangement of the bead. According to a first possibility (left-hand part in FIG. 5a) the bead 41 is situated straddling over the peripheral limit of the thin structure 2 and over the external edge of the spacer 30 only. According to a second possibility (right-hand part in FIG. 5a), the bead 42 is situated straddling over the peripheral limit of the thin structure 2, the external edge of the spacer 30 and also over at least part of the peripheral edge 12 of the spectacle base lens 1. In this second possibility, the bead 42 also participates in reducing the risks of delamination by rupture of the first assembly means, between the base lens 4 and the spacer 30.

In the second variant of permanent assembly, the spacer 30 is formed by several beads each of constant thickness. In other words, the spacer may comprise a stack of at least two spacer units, with a direction of the stack connecting the first respective surfaces of the spectacle base lens and the thin structure. Successive spacer units along the stack direction are then connected to each other by additional connection means. FIGS. 3b, 4b and 5b illustrate such a variant with two spacer units 30a and 30b, with an intermediate layer 30c of glue or adhesive material, for example pressure-sensitive adhesive, which is situated between the spacer units 30a and 30b. D designates the direction of stacking of the spacer units, which is also the direction of assembly of the thin structure 2 with the base lens 1. The spacer units and the additional connection means form together the spacer 30. The latter can then have a total thickness E that is easily adjustable, in a variant the number of spacer units that are stacked in the direction D. FIGS. 3b, 4b and 5b are derived directly from FIGS. 3a, 4a and 5a by modifying the structure of the spacer 30 as has just been described, so that it is not necessary to describe them in any further detail.

The left and right parts of FIGS. 5a and 5b furthermore illustrate two fashionings of the peripheral edge 12 of the spectacle base lens 1, which are known to persons skilled in the art and are compatible with the permanent assembly mode. It will be understood that these edge fashionings of the base lens 1 are independent of the type of bead 41 and 42 that is used to reinforce the connection or connections of the spacer 30 with the thin structure 2 (and the base lens 1). According to one of these possible fashionings, the peripheral edge 12 of the base lens 1 may be provided with a rim (left-hand parts of FIGS. 5a and 5b) 13 that is able to enter a recess in a hooped ophthalmic frame housing. Alternatively, the edge 12 of the base lens 1 may be provided with a groove (right-hand parts of FIGS. 5a and 5b) 14 that is able to receive a wire retaining the spectacle lens in an open ophthalmic frame housing. These two methods of mounting the spectacle lens in ophthalmic frames are known and very widely used.

FIGS. 6 and 7 moreover illustrate variants of a second embodiment of the invention, in which the base lens 1 and the thin structure 2 are assembled removably in the final spectacle lens with a spacer of complex shape. It is then possible to separate them, for example in order to associate the same base lens with another thin structure, so as to renew the thin structure if it is degraded, or to replace it with another thin structure in order to confer different functions on the final lens.

In a preferred manner, the assembly is removable at the level of the first assembly means 31, between the spectacle base lens 1 and the spacer 30. For this purpose, the first assembly means 31 may comprise a first rim of the spacer 30 that enters a groove in the spectacle base lens 1, situated on the peripheral edge 12 thereof. The direction D, perpendicular to the surfaces of the base lens 1 and to the thin structure 2 in the final lens, is transferred in FIGS. 6a to 6c with respect to the orientation of the spacer 30 in the final lens. The first rim of the spacer 30 is thus designated by the reference 31, and extends perpendicular to the direction D. FIGS. 7a to 7c show the removable assembly of such a spacer 30 on the peripheral edge 12 of the base lens 1, with the groove seen in cross-section and in which the first rim 31 enters. Such a removable assembly is obtained simply when the spacer 30 is in the form of a closed loop and consists of a flexible resilient material. In this way, the first rim 31 may in fact be introduced easily into the groove in the peripheral edge 12 all around the base lens 1, momentarily deforming the spacer 30. In addition, the length of the loop of the spacer 30 may be chosen so as to be a little smaller than the length of the peripheral edge 12 of the base lens 1, so that an elastic elongation of the spacer 30 ensures that it is held on the peripheral edge 12. The spacer 30 may also be made from polyurethane, preferably transparent. Possible dimensions of the spacer 30 in a section thereof may be, by way of example:

thickness e of the spacer 30, measured in the direction D and corresponding to the thickness of the separation space between the spectacle base lens 1 and the thin structure 2 in the final lens: 250 μm;

thickness e₁ of the spacer 30, measured in the direction D and corresponding to the distance between the first surface 10 and the groove that is situated in the peripheral edge 12 of the base lens 1: 400 μm;

thickness e₃₁ of the spacer 30, measured in the direction D and corresponding to the width of the groove that is situated in the peripheral edge 12 of the base lens 1: 550 μm;

width Δr₁ of the first rim 31, measured perpendicular to the direction D and corresponding to the depth of the groove that is situated in the peripheral edge 12 of the base lens 1: 600 μm; and

width Δr₂ of the second support surface of the spacer 30 measured perpendicular to the direction D and corresponding to the second assembly means 32: 900 μm.

Simultaneously and independently, the assembly may be either permanent or removable at the second assembly means 32, between the thin structure 2 and the spacer 30. FIGS. 6a and 7a illustrate a first variant in which the second assembly means 32 are permanent. For this purpose, the spacer 30 may have a support surface in its top part in the direction D that is identical to that already described in relation to FIGS. 3 to 5. The assembly means 32 may therefore once again form a fixed material connection, in particular by gluing or adhesion, between this second support surface of the spacer 30 and the first surface 20 of the thin structure 2.

FIGS. 6b and 7b illustrate a second variant in which the first assembly means 31 are again removable, and the second assembly means 32 are again permanent. The difference with the previous variant lies in the presence of a rib 35 around the second support face of the spacer 30. In this way, the spacer 30 has a profile with a cross-section with a re-entrant angle A from the second support surface. This angle A is then adapted to receive a peripheral limit of the thin structure 2, thus forming an alignment guide for assembly of the spacer 30 with the thin structure 2. The rib 35 may have a height e₂ of 350 μm, for example, measured parallel to the direction D. The thin structure 2 may then again be assembled with the spacer 30 by gluing or adhesion on the second support surface of the latter, in the angle A.

Finally, the assembly may also be removable at the second assembly means 32, between the thin structure 2 and the spacer 30, in addition to the first removable assembly means 31. Such a third variant is illustrated by FIGS. 6c and 7c. For this purpose, the second assembly means 32 may comprise a second rim 32 of the spacer 30, which projects over the second surface 21 of the thin structure 2 in the final spectacle lens. The thin structure 2 is thus gripped between the second support surface and the second rim 32 of the spacer 30. In fact, such a second rim 32 is situated at the end of the rib 35 introduced by the second removable assembly variant and extends perpendicular to this rib 35 in the direction of the centre of the spectacle lens. The second rim 32 may have the following dimensions:

thickness e₃ measured in the direction D: 250 μm; and

width measured perpendicular to the direction D: identical to that of the first rim 31.

Optionally, the second rim 32 may be provided with a bevel at its end towards the centre of the spectacle lens and on the anterior side thereof.

Naturally, the dimensions of the spacer 30, which have not been repeated for the second and third variants of the removable assemblies, may be identical to those cited for the first variant. The same applies to the possible materials for constituting the spacer 30 in the last variants. In particular, in the third variant, the thin structure 2 may be introduced easily between the second support surface and the second rim 31 of the spacer 30, momentarily deforming it.

To make it possible to easily mount in an ophthalmic mount spectacle lenses that result from the above removable assemblies, it may be convenient to adapt the spacer according to the type of mount. As with FIGS. 5a and 5b, the left-hand parts of FIGS. 7a, 7b and 7c show final lenses that are adapted to be mounted in mounts with hooped housings, and the right-hand parts of the same figures show final lenses that are adapted to be held by a wire in an open spectacle mount housing. Thus the spacer 30 may also have a projecting relief 33 on its external edge that is opposite to the spectacle base lens 1 and the thin structure 2, this projecting relief being adapted to enter the hooping recess of a spectacle mount housing. Alternatively, the spacer 30 may be provided on its external edge with a groove 34 that is adapted to receive the wire holding the spectacle lens in an open spectacle mount housing. In other words, the form of fashioning that is usually produced on the peripheral edge of a spectacle lens, to enable it to be mounted in various types of mount, can be transferred onto the external peripheral edge of the spacer 30 that is used in the present invention. In this case, this form of external peripheral edge may be created directly during moulding or extrusion of the spacer 30.

A method for producing a spectacle lens according to the invention is now described. First of all, the form of the housing of the lens in the mount is characterised, in a way that may be one of those known to persons skilled in the art. The spectacle base lens 1 and the spacer 30 are then produced in accordance with the housing of the mount. When the base lens 1 is intended itself to be directly in contact with the mount, as in the case in FIGS. 5a and 5b, the base lens 1 is trimmed according to a contour that is identical to that of the housing in the mount. Alternatively, when the spacer 30 is intended to be interposed between the base lens 1 and the mount, as in the case in FIGS. 7a to 7c, the base lens 1 must be trimmed according to a contour that is parallel to that of the housing of the mount, with an offset towards the centre of the lens that is equal to the difference in width Δr₂−Δr₁ of the spacer 30.

When the spacer 30 is in accordance with FIG. 3a or 3b, or it comprises more than two spacer units similar to the units 30a and 30b, it may be cut inside at least one sheet, for example a sheet of polyurethane of constant thickness. A known cutting tool may be used, which does not cause any shrinkage of elastic material and makes it possible to obtain the width Δr₁ that is required. For example, such a cutting can be carried out by means of a laser the emission wavelength of which has been suitably chosen according to the material of the spacer.

The thin structure 2 is also cut from a supply sheet provided with this structure, in accordance with the first surface 10 of the base lens 1, delimited by its peripheral edge 12.

According to one feature of the method of the invention, the thin structure 2 and the spacer 30 are first of all assembled with each other, separately from the base lens 1. This partial assembly may thus be effected in a specialist laboratory, using the second assembly means 32 in the way already described for each embodiment of the invention. The assembly that is thus obtained may then be sent to a retail optician, who will assemble it with the base lens 1, using the first assembly means 31 that have also already been described.

However, before being assembled with the base lens 1, the thin structure 2 or the assembly that comprises the thin structure 2 and the spacer 30 assembled with each other by the second assembly means 32 may be preformed in order to confer curvature on it. This performing may preferably be carried out after the spacer 30 has been assembled with the thin structure 2, when this assembly is permanent as in the case in FIGS. 5a, 5b, 7a and 7b. When this assembly is removable, as in the case in FIG. 7c, the performing may be applied to the thin structure 2 before it is assembled with the spacer 30. In all cases, the thin structure 2 then has a form that is substantially similar to that of the first surface 10 of the base lens 1.

Finally, when the thin structure 2 and the spacer 30 are assembled with each other permanently, the supplementary peripheral bead 41 or 42 can be applied as described with reference to FIGS. 5a and 5b. When this bead covers only the peripheral limit of the thin structure 2 and the external edge of the spacer 30, without projecting onto the peripheral edge 12 of the base lens 1, it can be applied to the assembly comprising the thin structure 2 and the spacer 30 after these have been assembled with each other. In other words, the bead 30, when it is used, is applied after the first assembly means have been used, but it may be applied thus before the second assembly means have themselves been used. On the other hand, the bead 42 that projects onto the peripheral edge 12 of the base lens 1 is necessarily applied after the thin structure 2 has been completely assembled with the base lens 1.

Naturally, the invention can be reproduced by introducing various modifications compared with the detailed description given above, while keeping at least some of the advantages mentioned. In particular, alternative embodiments that concern different parts of the spectacle lens of the invention can be combined with each other in any way. Furthermore, the dimensions and materials that have been cited were cited only by way of example to enable the invention to be reproduced, it being understood that these materials and dimensions may also be modified.

1. A spectacle lens comprising:
a spectacle base lens, rigid and delimited by a peripheral edge that laterally connects first and second opposite optical surfaces of said spectacle base lens;
a thin structure that is included between first and second parallel surfaces of said thin structure, and which extends in front of the first surface of the spectacle base lens; and
a spacer, wherein the spacer comprises:
a central part that extends along at least part of the peripheral edge of the spectacle base lens, and itself having a first support surface that is applied against the first surface of the spectacle base lens inside the peripheral edge, and a second support surface that is applied against the first surface of the thin structure, said first and second support surfaces of the spacer being opposite; and
a peripheral part continuously surrounding, by the periphery, the spectacle base lens and the thin structure, ensuring holding of these;
the spacer having a thickness (e) that is constant between the first and second support surfaces; and
a separation space determined by the spacer between the spectacle base lens and the thin structure containing a gaseous medium during use of the spectacle lens by a wearer.

2. The spectacle lens according to claim 1, wherein the spacer is comprised of two distinct pieces: a central part and a peripheral part.

3. The spectacle lens according to claim 2, wherein the central part of the spacer comprises a stack of at least two spacer units, with a direction of said stack connecting the first respective surfaces of the spectacle base lens and the thin structure, and successive spacer units along the stacking direction being connected together by additional connection means.

4. The spectacle lens according to claim 2, wherein the peripheral part comprises a peripheral bead situated straddling a peripheral limit of the thin structure connecting the first and second surfaces of said thin structure, and over at least part of an external edge of the central part of the spacer connecting the first and second support surfaces of said spacer.

5. The spectacle lens according to claim 4, wherein the peripheral bead is situated straddling the peripheral limit of the thin structure, the external edge of the spacer, and over at least part of the peripheral edge of the spectacle base lens.

6. The spectacle lens according to claim 1, wherein the spacer is formed in a single piece of complex shape and in which the first assembly means comprise a first rim of the spacer entering a groove in the spectacle base lens situated on the peripheral edge of said spectacle base lens.

7. The spectacle lens according to claim 6, wherein the second assembly means form a fixed material connection between the second support surface of the spacer and the first surface of the thin structure.

8. The spectacle lens according to claim 7, wherein the spacer has a cross-section profile with a re-entrant angle from the second support surface of said spacer, adapted to receive a peripheral limit of the thin structure.

9. The spectacle lens according to claim 6, wherein the second assembly means comprise a second rim of the spacer projecting over the second surface of the thin structure, so that said thin structure is gripped between the second support surface and the second rim of the spacer.

10. The spectacle lens according to claim 6, wherein the spacer includes a relief projecting over an external edge of said spacer opposite to the spectacle base lens and to the thin structure, said projecting relief being adapted to enter a hooping recess of a spectacle mount housing.

11. The spectacle lens according to claim 6, wherein the spacer includes a groove on an external edge of said spacer opposite to the spectacle base lens and to the thin structure, said groove being adapted to receive a wire for holding the spectacle lens in an open spectacle mount housing.

12. The spectacle lens according to claim 1, wherein the first surface of the spectacle base lens and at least one of the surfaces of the thin structure are provided with non-reflecting coatings.

13. The spectacle lens according to claim 1, wherein the thin structure has a multilayer formation in a direction perpendicular to the first and second surfaces of said thin structure, and comprises:
a layer of cells (C) juxtaposed parallel to said first and second surfaces of the thin structure; and
two films situated on either side of the layer of cells in said perpendicular direction.

14. The spectacle lens according to claim 1, wherein the thin structure has a multilayer formation in a direction perpendicular to the first and second surfaces of said thin structure, and comprises:
a base film 22;
a layer of cells (C) that are juxtaposed parallel to said first and second surfaces of the thin structure, carried by the base film;
a film for closing the cells, which is situated on one side of the layer of cells opposite to the base film;
a first non-reflecting coating carried by the cell-closing film on a side opposite to the layer of cells;
an additional film that is situated on one side of the base film opposite to the layer of cells;
a second non-reflecting coating that is carried by the additional film on a side opposite to the base film; and
connection means connecting the additional film to the base film on a side of said additional film opposite to the second non-reflecting coating.

15. A method for producing a spectacle lens, said spectacle lens being in accordance with claim 1, and said method comprising the following steps:
(a) obtaining a characterisation of a lens housing shape in a frame that is intended to receive the spectacle lens;
(b) trimming the spectacle base lens and producing the spacer in accordance with the housing in the frame;
(c) cutting the thin structure in accordance with the first surface of the base lens;
(d) assembling the spacer with the thin structure using the second assembly means); and then
(e) after step (d), assembling the whole set comprising the thin structure and the spacer with the spectacle base lens using the first assembly means.

16. The method according to claim 15, wherein the peripheral part comprises a peripheral bead situated straddling a peripheral limit of the thin structure connecting the first and second surfaces of said thin structure, and over at least part of an external edge of the central part of the spacer connecting the first and second support surfaces of said spacer, and wherein the peripheral bead is applied onto the assembly comprising the thin structure and the spacer after step (d).

17. The method according to claim 16, wherein the peripheral bead is situated straddling the peripheral limit of the thin structure, the external edge of the spacer, and over at least part of the peripheral edge of the spectacle base lens and wherein the peripheral bead is applied after step (e).
